(19) United States
(12) Patent Application Publication
(10) Pub. No.: US 2017/0029747 A1
(43) Pub. Date: Feb. 2, 2017

(54) WATER-SOLUBLE UNIT DOSE ARTICLE

(71) Applicant: The Procter & Gamble Company, Cincinnati, OH (US)

(72) Inventors: Karel Jozef Maria DEPOOT, Anzegem-Vichte (BE); Jean-Francois BODET, Waterloo (BE); Oreste TODINI, Brussels (BE); Wouter WALRAVENS, Humbeek (BE)

(21) Appl. No.: 15/214,489

(22) Filed: Jul. 20, 2016

(30) Foreign Application Priority Data
Jul. 30, 2015 (EP) 15179152.2

(51) Int. Cl. C11D 11/00; C11D 1/22; C11D 1/66; C11D 3/37; C11D 3/20; C11D 3/30; C11D 3/22; C11D 1/83; C11D 17/04; C11D 1/29

(52) U.S. Cl. CPC C11D 11/0017; C11D 17/043; C11D 1/22; C11D 1/66; C11D 1/29; C11D 3/2068; C11D 3/30; C11D 3/225; C11D 17/045; C11D 1/83; C11D 3/222; C11D 3/3753

(57) ABSTRACT

A water-soluble unit dose article comprising a water-soluble film and a liquid laundry detergent composition, wherein the laundry detergent composition comprises a first anionic surfactant, a second anionic surfactant, a non-ionic surfactant, between 0.5% and 20% by weight of the detergent composition of water, wherein the weight ratio of the first amine neutralized anionic surfactant:the sum of the second amine neutralized anionic surfactant and the nonionic surfactant is between 1.3:1 and 3:1.

### FIELD OF THE INVENTION

The present invention relates to water-soluble unit dose articles for use in laundry operations and methods of their use.

### BACKGROUND OF THE INVENTION

Water-soluble unit dose articles are liked by consumers as they are efficient and easy to use. However, such products suffer from the drawback of having limited space available for formulation flexibility due to the inherent small volumes being used. Therefore, often the detergent composition can be tailored to be effective against a particular stain however it may not be as effective as desired against another type of stain.

There is need in the art for a water-soluble unit dose article that provides effective cleaning on both grease and grass stains. Both stains are commonly found on fabrics to be washed at the same time, especially children's fabrics. Therefore consumers desire a cleaning product that can effectively remove both stain types during a single wash operation.

The Inventors surprisingly found that the specific formulation space of the present invention providing a unit dose article that when used in a wash operation resulted in effective removal of both grease and grass stain from the fabrics in a single wash operation.

### SUMMARY OF THE INVENTION

A first aspect of the present invention is a water-soluble unit dose article comprising a water-soluble film and a liquid laundry detergent composition, wherein the laundry detergent composition comprises;
a. between 10% and 45% by weight of the detergent composition of a first anionic surfactant wherein the first anionic surfactant is an amine neutralised linear alkylbenzene sulphonate;
b. a second anionic surfactant wherein the second anionic surfactant is an amine neutralised alkyl sulphate;
c. optionally an amine neutralised soap;
d. a non-ionic surfactant;
e. optionally a hydrophobically-modified polymer;
f. between 0.5% and 20% by weight of the detergent composition of water;

wherein;

the weight ratio of the first amine neutralized anionic surfactant:the sum of the second amine neutralized anionic surfactant and the nonionic surfactant is between 1.3:1 and 3:1; and

the weight ratio of the first amine neutralized anionic surfactant:amine neutralized soap is between 1:0 and 1:0.45.

A second aspect of the present invention is a method of doing laundry comprising the steps of diluting a water-soluble unit dose article according to the present invention in water by a factor of at least 350 to form a wash liquor and then washing fabrics with said wash liquor.

### DETAILED DESCRIPTION OF THE INVENTION

### Water-Soluble Unit Dose Article

The present invention is to a water-soluble unit dose article comprising a water-soluble film and a liquid laundry detergent composition.

The water-soluble unit dose article comprises at least one water-soluble film shaped such that the unit dose article comprises at least one internal compartment surrounded by the water-soluble film. The at least one compartment comprises the liquid cleaning composition. The water-soluble film is sealed such that the composition does not leak out of the compartment during storage. However, upon addition of the water-soluble unit dose article to water, the water-soluble film dissolves and releases the contents of the internal compartment into the wash liquor.

The unit dose article is manufactured such that the water-soluble film completely surrounds the composition and in doing so defines the compartment in which the composition resides. The unit dose article may comprise two films, or even three films. A first film may be shaped to comprise an open compartment into which the composition is added. A second film may then be laid over the first film in such an orientation as to close the opening of the compartment. The first and second films may then be sealed together along a seal region.

The water-soluble unit dose article may comprise two, or even three, or even four internal compartments, preferably wherein the compartments are arranged side-by-side, in a superposed orientation or a mixture thereof. The compartments may be arranged such that two side-by-side compartments are superposed onto a third compartment wherein the third compartment is larger than the first and/or second compartments. Alternatively, the compartments may be arranged such that three side-by-side compartments are superposed onto a fourth compartment wherein the fourth compartment is larger than the first and/or second and/or third compartments.

The unit dose article may be transparent, translucent or opaque. The water-soluble film may be transparent, translucent or opaque, the liquid cleaning composition may be transparent, translucent or opaque or a mixture thereof.

Water-soluble unit dose articles include products supplied by The Procter and Gamble Company under the following names TIDE PODS, CASCADE ACTION PACS, CASCADE PLATINUM, CASCADE COMPLETE, ARIEL 3 IN 1 PODS, TIDE BOOST ORIGINAL DUO PACs, TIDE BOOST FEBREZE SPORT DUO PACS, TIDE BOOST VIVID WHITE BRIGHT PACS, DASH, FAIRY PLATINUM.

The water-soluble unit dose article comprises a water-soluble film. The water-soluble film is described in more detail below.

The water soluble unit dose article comprises a liquid laundry detergent composition. The liquid laundry detergent composition is described in more detail below.

The water-soluble unit dose article may comprise an aversive agent, preferably a bittering agent. The aversive agent may be located in the detergent composition, within the water-soluble film, on the external surface of the water-soluble unit dose article or a mixture thereof.

By ‘aversive agent’ we herein mean any compound that provides an unpleasant taste when placed in the mouth or ingested. Such unpleasant tastes include bitterness, heat/spice, unpleasant odour, sourness, coldness or a mixture thereof. The aversive agent may be a bittering agent. Preferably the aversive agent is at a concentration which is safe and which elicits oral repulsive behaviour within a maximum time of 6 seconds in case of accidental oral exposure.

Suitable bittering agents include naringin, sucrose octaacetate, quinine hydrochloride, denatonium benzoate and mixtures of these. The bittering agent may have a bitter value of between 1000 and 10,000,000 as measured using the standardized process is used that is set forth in the European Pharmacopoeia (5th Edition, Stuttgart 2005, Volume 1, General Monograph Groups, 2.8.15 Bitterness Value, p. 278).

The aversive agent may be selected from the group comprising capsicinoids (including capsaicin); vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-rnethoxy-4′-hydroxy-phenyl)-1, 3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

### Liquid Laundry Detergent Composition

The water-soluble unit dose article comprises a liquid laundry detergent composition. By ‘liquid’ we herein mean any composition capable of wetting and treating a substrate and encompasses forms such as dispersions, gels, pastes and the like. A dispersion, for example, is a liquid comprising solid or particulate matter contained therein. The liquid composition may also include gases in suitably subdivided form.

By ‘fabric detergent’ we herein mean any composition that provides cleaning and/or stain removal benefit to fabrics. Such a composition may comprise one or more further benefits such as softening, color protection, pill/fuzz reduction, anti-abrasion, anti-wrinkle, or mixtures thereof.

The laundry detergent composition comprises between 10% and 45%, preferably between 20% and 37.5%, more preferably between 20% and 35% by weight of the detergent composition of a first anionic surfactant wherein the first anionic surfactant is an amine neutralised linear alkylbenzene sulphonate. The laundry detergent composition furthermore comprises a second anionic surfactant wherein the second anionic surfactant is an amine neutralised alky sulphate. The weight ratio of the first amine neutralized anionic surfactant:the sum of the second amine neutralized anionic surfactant and the nonionic surfactant is between 1.3:1 and 3:1; preferably between 1.5:1 and 2.7:1. The ‘sum of the second amine neutralized anionic surfactant and the nonionic surfactant’ means the combined weight percentage of the second amine neutralized anionic surfactant and the nonionic surfactant in the liquid laundry detergent composition.

Without wishing to be bound by theory, it is believed that the careful balance of the surfactants relative to one another in the low water composition overcame the technical problem. It was also surprisingly found that the present invention provided improved mildness benefits.

The first anionic surfactant is an amine neutralized linear alkylbenzene sulphonate. By ‘amine neutralised’ we herein mean that the acid form of the surfactant is neutralized to the corresponding salt using an amine compound, preferably monoethanolamine, triethanolamine or a mixture thereof.

The linear alkylbenzene sulphonates may be a C₁₀-C₁₆ alkyl benzene sulfonates, a C₁₁-C₁₄ alkyl benzene sulphonates, or a mixture thereof. By ‘linear’, we herein mean the alkyl group is linear.

The second anionic surfactant is an amine neutralised alky sulphate. By ‘amine neutralised’ we herein mean that the acid form of the surfactant is neutralized to the corresponding salt using an amine compound, preferably monoethanolamine, triethanolamine or a mixture thereof. Preferably, the second surfactant is an ethoxylated alkyl sulphate, preferably wherein the ethoxylated alkyl sulphate has an average degree of ethoxylation of between 0.5 and 5, or preferably between 1 and 3. The second surfactant may have an alkyl chain length between 10 and 18, preferably between 12 and 16. The second surfactant may be linear or branched.

The liquid laundry detergent composition may comprise an amine neutralised soap. By this we mean a fatty acid that has been neutralized to the corresponding soap using an amine compound, preferably wherein the amine is selected from monoethanolamine, triethanolamine or a mixture thereof. The weight ratio of the first amine neutralized anionic surfactant:amine neutralized soap is between 1:0 and 1:0.45. preferably between 1:0.1 and 1:0.42.

Preferably, the first surfactant, the second surfactant, the amine neutralised soap or a mixture thereof are neutralised with monethanolamine, triethanolamine or a mixture thereof. Preferred soaps are selected from fatty acids derived from the group consisting of lauric acid, myristic acid, palmitic acid, stearic acid, topped palm kernel fatty acid, coconut fatty acid and mixtures thereof.

The liquid laundry detergent composition comprises between 0.5% and 20%, preferably between 0.5% and 1.5%, more preferably between 0.5% and 15%, most preferably between 0.5% and 13.5% by weight of the detergent composition of water.

The liquid laundry detergent composition comprises a non-ionic surfactant. The liquid laundry detergent composition may comprise from 0.1% to 10%, preferably from 0.5% to 8%, more preferably from 0.75% to 6% by weight of the liquid laundry detergent composition of a non-ionic surfactant. The non-ionic surfactant is preferably selected from fatty alcohol ethoxylate non-ionic surfactants, oxo-synthesised non-ionic surfactants, guerbet non-ionic surfactants and mixtures thereof.

Liquid laundry detergent composition optionally comprises a hydrophobically-modified polymer. The liquid laundry detergent composition may comprise between 1% and 8% by weight of the composition of a hydrophobically modified polymer. Preferably, the hydrophobically-modified polymer is a polyethylene glycol-containing polymer. In other words, the polymer comprises a polyethylene glycol, for example, a polyethylene glycol backbone. More preferably, the polyethylene glycol-containing polymer is selected from polymers having a polyethylene glycol backbone grafted with at least one vinyl acetate chain, a polyethylene glycol backbone grafted with at least one polyvinyl alcohol chain and mixtures thereof.

The liquid laundry detergent composition may comprise an ethoxylated polyethyleneimine. Preferably, the liquid laundry detergent composition may comprise between 1% and 8% by weight of the composition of an ethoxylated polyethyleneimine.

The liquid laundry detergent composition may comprise a cellulosic polymer. Preferably, the cellulosic polymer is selected from hydrophobically modified hydroxyethylcellulose, cationically modified hydroxyethylcellulose, carboxymethylcellulose and mixtures thereof.

The liquid laundry detergent composition may comprise a laundry adjunct ingredient wherein the laundry adjunct ingredient is preferably selected from the group comprising hueing dyes, enzymes, structurants, brighteners, chelants, aesthetic dyes, perfumes, encapsulated perfumes, fabric care ingredients, soil suspension or soil release polymers, non-aqueous solvents, aversive agents and mixtures thereof.

### Water-Soluble Film

The unit dose article of the present invention comprises a water-soluble film. Preferably the water-soluble film has a thickness of between 20 microns and 100 microns.

The water-soluble film prior to being made into a water-soluble unit dose article preferably has a thickness between 30 μm and 100 μm, preferably between 50 μm and 100 μm, even more preferably between 65 μm and 88 μm, most preferably between 76 μm and 85 μm. Herein we mean the thickness of the film before it has been subjected to any thermoforming or plasticization techniques such as thermoforming into a mould for example.

The film of the present invention is soluble or dispersible in water.

Preferably, the film has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer, Labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Of the total PVA resin content in the film described herein, the PVA resin can comprise about 30 to about 85 wt % of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

Alternatively for use herein are commercially available polyvinyl alcohols (PVA) obtained by hydrolysis of polyvinyl acetates. The solubility of these films can be selectively adjusted by the degree of hydrolysis of the PVA or by using a cross-linking agent. Preferably, the film comprises polyvinyl acetate with a degree of hydrolysis of from about 90 to about 99%, preferably from about 92 to about 98% and more preferably from about 94 to about 98%. The degree of hydrolysis is expressed as a percentage of vinyl acetate units converted to vinyl alcohol units.

Examples of commercially available PVA suitable for use herein are BP26 available from Aicello, L10 and L15 available from Aquafilm, VF-M and VM-S available from Kuraray and E-2060 available from Monosol, especially preferred for use herein is BP26 available from Aicello. The thickness of the material can influence the dissolution kinetics, films having a thickness between about 1 and about 200, more preferably between 10 and 100 μm are preferred for use herein.

Other preferred materials for use herein are starch, starch derivatives, cellulose and cellulose derivatives, more especially methyl cellulose and mixture thereof. Especially preferred for use herein are polymers comprising hydroxypropylmethylcellulose.

Preferred films are those supplied by Monosol under the trade references M8630, M8900, M8779, M8310, M9467. Suitable films for use in the present invention include those supplied by Monosol for use in the following Procter and Gamble products: TIDE PODS, CASCADE ACTION PACS, CASCADE PLATINUM, CASCADE COMPLETE, ARIEL 3 IN 1 PODS, TIDE BOOST ORIGINAL DUO PACs, TIDE BOOST FEBREZE SPORT DUO PACS, TIDE BOOST VIVID WHITE BRIGHT PACS, DASH, FAIRY PLATINUM.

The film used in the present invention may have the same chemistry as that used in products purchased from a UK supermarket on 21 May 2015 under the Ariel Pods 3in1 brand. The outer container was an opaque rigid tub generally green in colour and comprised the barcode 4 015600 385392.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or may be comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

### Method of Laundry

The present invention is also to a method of doing laundry comprising the steps of diluting a water-soluble unit dose article according to the present invention in water by a factor of at least 350 to form a wash liquor and then washing fabrics with said wash liquor.

The unit dose article of the present invention may be used alone in the wash operation or may be used in conjunction with other laundry additives such as fabric softeners or fabric stain removers. The unit dose article may be used in conjunction with fragrance boosting compositions such as commercially available ‘Lenor Unstopables’.

### EXAMPLES

The following are non-limiting examples of compositions according to the present invention (ingredient levels expressed as percentage by weight of the composition). Each composition was formulated into multicompartment unit dose composition wherein the water-soluble film comprised polyvinyl alcohol. The water-soluble film comprised the bittering agent, denatonium benzoate, commercially available from McFarland Smith under the tradename Bitrex.

TABLE 1

| | Detergent Composition | | | |
|---|---|---|---|---|
| | 1 | 2 | 3 | 4 |
| C₁₂₋₁₄ fatty alcohol ethoxylate having an average | 4.5 | 4.5 | 4.5 | 4.5 |
| degree of ethoxylation of 7 | | | | |
| Linear alkylbenzene sulphonate neutralized with | 29.7 | 32.4 | 29.7 | 32.4 |
| monethanolamine | | | | |
| C₁₂₋₁₄ ethoxylated alkyl sulphate having an average | 12.1 | 9.4 | 12.1 | 9.4 |
| degree of ethoxylation of 3 neutralized with | | | | |
| monoethanolamine | | | | |
| Citric acid | 0.63 | 0.63 | 0.63 | 0.63 |
| Topped palm kernel fatty acid neutralized with | 8.9 | 13 | 6.23 | 9.1 |
| monoethanolamine | | | | |
| Protease | 0.05 | 0.05 | 0.05 | 0.05 |
| Amylase | 0.003 | 0.003 | 0.003 | 0.003 |
| Ethoxylated polyethylene imine | 3.1 | 3.1 | 3.1 | 3.1 |
| Polyethylene glycol containing polymer | 1.5 | 1.5 | 1.5 | 1.5 |
| HEDP | 0.8 | 0.8 | 0.8 | 0.8 |
| Brightener 49 | 0.3 | 0.3 | 0.3 | 0.3 |
| Silicone suds suppressor | 0.3 | 0.3 | 0.3 | 0.3 |
| Hueing dye | 0 | 0.05 | 0 | 0.05 |
| 1,2 PropaneDiol | 17.2 | 13 | 17.2 | 13 |
| Glycerine | 4.7 | 4.7 | 4.7 | 4.7 |
| DiPropyleneGlycol | 0.5 | 0.5 | 0.5 | 0.5 |
| MonoEthanolAmine Trim to pH 7.4 (10% solution) | 1.07 | 1.07 | 1.48 | 1.66 |
| K2SO3 | 0.15 | 0.15 | 0.15 | 0.15 |
| MgCl2 | 0.3 | 0.3 | 0.3 | 0.3 |
| Water | 9.5 | 10.7 | 9.5 | 10.7 |
| Hydrogenated castor oil | 0.13 | 0.13 | 0.13 | 0.13 |
| Perfume | 2.6 | 2.6 | 2.6 | 2.6 |
| Perfume micro capsules (expressed as encapsulated | 0.7 | 0.7 | 0.7 | 0.7 |
| oil) | | | | |
| Acrylate-based opacifier | 0.3 | 0.3 | 0.3 | 0.3 |
| Minors | 0.9 | 0 | 3.2 | 3.1 |
| Aesthetic dye | 0.04 | 0.04 | 0.04 | 0.04 |
| Polyvinylalcohol film | Present | Present | Present | Present |
| Weight ratio of (Linear alkylbenzene sulphonate | 1.79:1 | 2.33:1 | 1.79:1 | 2.33:1 |
| neutralized with monethanolamine):((C₁₂₋₁₄ fatty | | | | |
| alcohol ethoxylate having an average degree of | | | | |
| ethoxylation of 7) + (C₁₂₋₁₄ ethoxylated alkyl | | | | |
| sulphate having an average degree of ethoxylation | | | | |
| of 3 neutralized with monoethanolamine) | | | | |
| Weight ratio of Linear alkylbenzene sulphonate | 1:0.30 | 1:0.40 | 1:0.21 | 1:0.28 |
| neutralized with monethanolamine:topped palm | | | | |
| kernel fatty acid neutralized with | | | | |
| monoethanolamine | | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble unit dose article comprising a water-soluble film and a liquid laundry detergent composition, wherein the laundry detergent composition comprises:
a. between about 10% and about 45% by weight of the detergent composition of a first anionic surfactant wherein the first anionic surfactant is an amine neutralised linear alkylbenzene sulphonate;
b. a second anionic surfactant wherein the second anionic surfactant is an amine neutralised alkyl sulphate;
c. optionally an amine neutralised soap;
d. a non-ionic surfactant;
e. optionally a hydrophobically-modified polymer;
f. between about 0.5% and about 20% by weight of the detergent composition of water;
wherein;
the weight ratio of the first amine neutralized anionic surfactant:the sum of the second amine neutralized anionic surfactant and the nonionic surfactant is between about 1.3:1 and about 3:1; and
the weight ratio of the first amine neutralized anionic surfactant:amine neutralized soap is between about 1:0 and about 1:0.45.

2. The water-soluble unit dose article according to claim 1 comprising between about 20% and about 40%, by weight of the detergent composition of the first anionic surfactant

3. The water-soluble unit dose article according to claim 2 comprising between about 20% and about 35% by weight of the detergent composition of the first anionic surfactant.

4. The water-soluble unit dose article according to claim 1 wherein the second surfactant is an ethoxylated alkyl sulphate.

5. The water-soluble unit dose article according to claim 4 wherein the ethoxylated alkyl sulphate has an average degree of ethoxylation of between about 0.5 and about 5.

6. The water-soluble unit dose article according to claim 5 wherein the ethoxylated alkyl sulphate has an average degree of ethoxylation of between about 1 and about 3.

7. The water-soluble unit dose article according to claim 1 wherein the weight ratio of the first amine neutralized anionic surfactant:the sum of the second amine neutralized anionic surfactant and the non-ionic surfactant is between about 1.5:1 and about 2.7:1.

8. The water-soluble unit dose article according to claim 1 wherein the detergent composition comprises between about 0.5% and about 15%.

9. The water-soluble unit dose article according to claim 1 wherein the first surfactant, the second surfactant, the amine neutralised soap or a mixture thereof are neutralised with monethanolamine, triethanolamine or a mixture thereof.

10. The water-soluble unit dose article according to claim 1 wherein the liquid laundry detergent composition comprises a hydrophobically-modified polymer.

11. The water-soluble unit dose article according to claim 10 wherein the hydrophobically-modified polymer is a polyethylene glycol-containing polymer.

12. The water-soluble unit dose article according to claim 11 wherein the polyethylene glycol-containing polymer is selected from polymers having a polyethylene glycol backbone grafted with at least one vinyl acetate chain, a polyethylene glycol backbone grafted with at least one polyvinyl alcohol chain, and mixtures thereof.

13. The water-soluble unit dose article according to claim 1 wherein the non-ionic surfactant is selected from fatty alcohol ethoxylate non-ionic surfactants, oxo-synthesised non-ionic surfactants, guerbet non-ionic surfactants, and mixtures thereof.

14. The water-soluble unit dose article according to claim 1 wherein the liquid laundry detergent composition comprises a cellulosic polymer.

15. The water-soluble unit dose article according to claim 16 wherein the cellulosic polymer is selected from hydrophobically modified hydroxyethylcellulose, cationically modified hydroxyethylcellulose, carboxymethylcellulose and mixtures thereof.

16. The water-soluble unit dose article according to claim 1 comprising a laundry adjunct ingredient wherein the laundry adjunct ingredient is selected from the group comprising hueing dyes, enzymes, structurants, brighteners, chelants, aesthetic dyes, perfumes, encapsulated perfumes, non-aqueous solvents, fabric care ingredients, soil release polymers, soil suspending polymers, aversive agents and mixtures thereof.

17. The water-soluble unit dose article according to claim 1 comprising an aversive agent, and wherein the aversive agent is located in the detergent composition, within the water-soluble film, on the external surface of the water-soluble unit dose article or a mixture thereof.

18. The water-soluble unit dose article according to claim 1 wherein the water-soluble film comprises polyvinyl alcohol.

19. The water-soluble unit dose article according to claim 1 wherein the water-soluble pouch comprises at least two, internal compartments.

20. A method of doing laundry comprising the steps of diluting a water-soluble unit dose article according to claim 1 in water by a factor of at least about 350 to form a wash liquor and then washing fabrics with said wash liquor.
